(19) United States
(12) Patent Application Publication
(10) Pub. No.: US 2008/0020175 A1
(43) Pub. Date: Jan. 24, 2008

(54) Nanostructured Indium-Doped Iron Oxide

(76) Inventor: Fred Ratel, Tucson, AZ (US)

Correspondence Address: SHEPPARD MULLIN RICHTER & HAMPTON LLP, 48th Floor, 333 South Hope Street, Los Angeles, CA, 90071, US

(21) Appl. No.: 11/681,685

(22) Filed: Mar. 2, 2007

Related U.S. Application Data
(60) Provisional application No. 60/778,729, filed on Mar. 2, 2006.

(51) Int. Cl. B32B 5/12; B05D 1/10

(52) U.S. Cl. 428/105; 427/201

(57) ABSTRACT

The present invention generally relates to materials that may be used to construct photoelectrodes. It more specifically relates to nanostructured indium-doped iron oxide materials that may be used as photoanodes in photoelectrochemical cells which catalyze the splitting of water into its component gasses using sunlight as the energy source. In a composition aspect, the present invention provides an indium-doped iron oxide film. The film ranges in thickness from 20 nm to 200 nm, and has less than 10% indium by weight, less than 10% Fe₂O₃ and In₂O₃ by weight and less than 10% indium ferrate by weight. There are at least 10 disc-like structures on the film surface within a 0.25 μm² area, and the disc-like structures are roughly spherical in shape with a ratio of long dimension to short being at least 2:1. The radius of the disc-like structures ranges from 0.25 nm to 6 nm, and the disc-like structures are oriented at an angle between 20° and 160° relative to the film surface plane.

### CROSS-REFERENCE TO RELATED APPLICATION

This application claims priority to U.S. Provisional Patent Application Ser. No. 60/778,729 filed on Mar. 2, 2006, the entire disclosure of which is incorporated by reference.

### FIELD OF THE INVENTION

The present invention generally relates to materials that may be used to construct photoelectrodes. It more specifically relates to nanostructured indium-doped iron oxide materials that may be used in photoanodes for the electrochemical splitting of water using sunlight as the energy source.

### BACKGROUND OF THE INVENTION

There is an interest among researchers directed to the splitting of water through the use of semiconducting photoelectrodes exposed to visible light. This interest has resulted in several journal reports, including the following: R. Asahi, T. Morikawa, T. Ohwaki, K. Aoki, Y. Taga, Science (Washington, D.C., United States) 293 (2001) 269; S. U. M. Khan, M. Al-Shahry, W. B. Ingler Jr., Science (Washington, D.C., United States) 297 (2002) 2243; C. Jorand Sartoretti, M. Ulmann, B. D. Alexander, J. Augustynski, A. Weidenkaff, J. Chemical Physics Letters 376 (2003) 194-200; and, W. B. Ingler Jr., S. U. M. Khan, Electrochemical Society Proceedings 2004-2006 (2004) 124 (“Khan”).

Khan discusses the fabrication of indium-doped n-Fe₂O₃ thin films. The article reports that spray pyrolytic deposition was used to form the films on tin oxide-coated, glass substrates. Khan states that the deposition procedure involved spray solutions of 0.11 M FeCl₃.6H₂O having various concentrations—0.0022M to 0.011M—InCl₃.6H₂O in absolute ethanol. The solutions were sprayed onto the tin oxide coated glass, which exhibited a temperature ranging from 683K (i.e., 410° C.) to 698K (i.e., 425° C.), using oxygen as a carrier gas.

According to Kahn, XRD plots were run for optimized thin films of indium-doped n-Fe₂O₃ made with 0.0033 M to 0.0077M indium dopant with 0.11M iron chloride. The plots were interpreted as follows: The thin films are made-up of at least three different compounds—Fe₂O₃, In₂O₃, and InFeO₃. Indium doping is at a 1.5% level relative to other elements present.

Kahn concluded the article by discussing that indium doping appeared to improve the conductivity of films, accordingly increasing the photocurrent over pure n-Fe₂O₃ thin films. Furthermore, an optimal substrate temperature for the film deposition of 688 K (i.e., 415° C.) was observed.

Despite reports such as Kahn's, there remains a need in the art for improved indium-doped Fe₂O₃ materials that may be used in a photoanode. That is an object of the present invention.

### SUMMARY OF THE INVENTION

The present invention generally relates to materials that may be used to construct photoelectrodes. It more specifically relates to nanostructured indium-doped iron oxide materials that may be used in photoelectrodes, wherein indium is incorporated into the crystal lattice of the α-hematite phase of Fe₂O₃, resulting in a new composition of matter.

In a composition aspect, the present invention provides an indium-doped iron oxide film. The film ranges in thickness from 20 nm to 200 nm, and has less than 10% indium by weight, less than 10% Fe₂O₃ and In₂O₃ by weight and less than 10% indium ferrate by weight. There are at least 10 disc-like structures on the film surface within a 0.25 μm² area, and the disc-like structures are roughly spherical in shape with a ratio of long dimension to short being at least 2:1. The radius of the disc-like structures ranges from 0.25 nm to 6 nm, and the disc-like structures are oriented at an angle between 20° and 160° relative to the film surface plane.

In a method aspect, the present invention provides a method of producing an indium-doped iron oxide film. The method comprises the steps of: a) generating a micron-sized aerosol of an indium-doped iron oxide precursor solution, wherein the precursor solution comprises an iron-based organometallic at a concentration ranging from 0.001M to 0.02 M and an indium compound at a concentration ranging from 0.00004M to 0.0008M in either an organic alcohol or ether; b) directing the aerosol to a heated substrate, wherein the substrate is either a: a) spectrally transparent glass with a conductive overlayer, or, b) spectrally transparent cyclic-olefin copolymer or poly(norbornene), and wherein the substrate temperature is less than 400° C.; and, c) allowing the indium-doped iron oxide precursor to pyrolyze on the substrate surface thereby forming the indium-doped iron oxide film, wherein the indium-doped iron oxide is less than 10% indium by weight, and less than 10% Fe₂O₃ and In₂O₃ by weight, and less than 10% indium ferrate by weight.

In an article of manufacture aspect, the present invention provides a photo-anode. The photo-anode comprises a conductive substrate and an indium-doped iron oxide film. The substrate is either a: a) spectrally transparent glass with a conductive overlayer, or, b) spectrally transparent cyclic-olefin copolymer or poly(norbornene). The indium-doped iron oxide film ranges in thickness from 20 nm to 200 nm, and the film is less than 10% indium by weight, less than 10% Fe₂O₃ and In₂O₃ by weight and less than 10% indium ferrate by weight. There are at least 10 disc-like structures on the film surface within a 0.25 μm² area, and the disc-like structures are roughly spherical in shape with a ratio of long dimension to short being at least 2:1. The radius of the disc-like structures ranges from 0.25 nm to 6 nm, and the disc-like structures are oriented at an angle between 20° and 160° relative to the film surface plane.

### BRIEF DESCRIPTION OF THE FIGURES

FIG. 1 shows a flow chart illustrating a procedure to make indium-doped iron oxide films according to the present invention.

FIG. 2 shows an ultrasonic spray pyrolysis apparatus used to make indium-doped iron oxide films according to the present invention.

### DETAILED DESCRIPTION

The present invention generally relates to materials that may be used to construct photoelectrodes. It more specifically relates to nanostructured indium-doped iron oxide materials that may be used as photoanodes.

The nanostructured indium-doped iron oxide materials are typically formed as films on a substrate. Film thickness usually ranges from 20 nm to 200 nm. Oftentimes, the film thickness ranges from 50 nm to 160 nm or 80 nm to 120 nm. In certain cases, the film thickness is approximately 100 nm.

The indium-doped iron oxide materials of the present invention typically do not contain more than 10% by weight of indium. Oftentimes, the materials contain an amount of indium ranging from 2% to 10% by weight. In certain cases, the materials contain an amount of indium ranging from 3% to 7% or 3.5% to 5% by weight.

The present indium-doped iron oxide materials are typically a single-phase material. The materials do not include a significant amount of either Fe₂O₃ or In₂O₃. They typically contain less than 10% Fe₂O₃ and/or In₂O₃, and oftentimes they contain less than 5% Fe₂O₃ and/or In₂O₃. Furthermore, the materials do not include a significant amount of indium-ferrate, which has a cubic structure. Typically, they contain less than 10% indium ferrate, with less than 5% indium ferrate being more common.

The surface of films of the present indium-doped iron oxide materials typically exhibit disc-like structures. Such structures are relatively spherical, with the ratio of long dimension to short dimension being at least 2:1. Oftentimes the ratio is at least 3:1 or 4:1. In certain cases, the ratio is at least 5:1 or 6:1.

The radius of the disc-like structures typically ranges from 0.25 nm to 6 nm. Oftentimes the radius ranges from 0.38 nm to 5.5 nm, and in certain cases it ranges from 0.5 nm to 5.1 nm.

Disc-like structures of the present invention are typically oriented at an angle between 20° and 160° relative to the surface plane. Oftentimes, the structures are oriented at an angle between 40° and 140° or between 60° and 120° relative to the surface plane. In certain cases, the disc-like structures are oriented at a angle of approximately 90°.

The indium-doped iron oxide films of the present invention typically contain at least 10 disc-like structures on their surface within a 0.25 μm² area. Oftentimes, the films contain at least 25 or 50 disc-like structures on their surface within a 0.25 μm² area. In certain cases, the films contain at least 75 or 100 disc-like structures on their surface within a 0.25 μm² area.

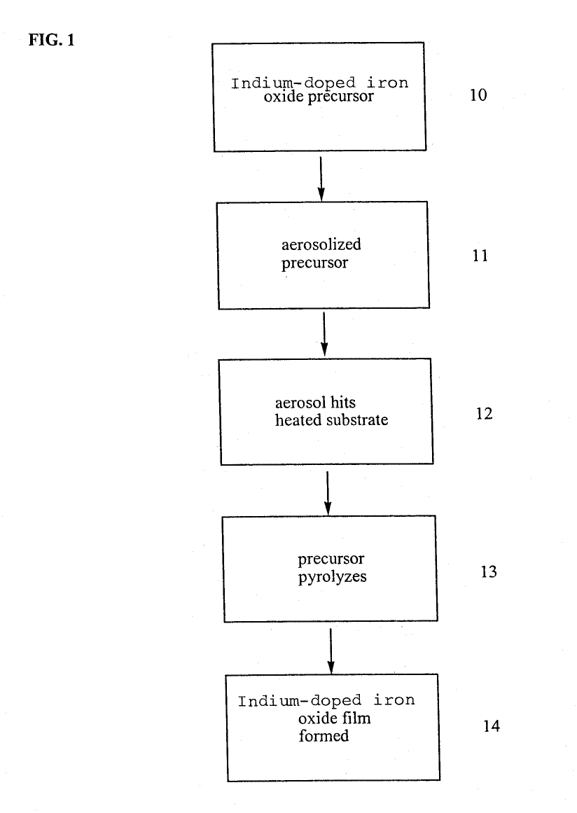

The indium-doped iron oxide films are typically formed using an ultrasonic spray pyrolysis procedure, which is generally described in reference to FIG. 1. An indium-doped iron oxide precursor solution (10) is aerosolized (11). The aerosol hits a heated substrate (12); the solvent is evaporated; and, the precursor pyrolyzes (13) to form the indium-doped iron oxide film (14).

The indium-doped iron oxide precursor solution is typically a dilute solution of an iron-based organometallic and an indium-based organometallic compound dissolved in an organic solvent. “Iron-based organometallic” refers to an iron compound that has ligands containing carbon. Oftentimes, the iron compound is either an Fe(III) compound or an Fe(0) compound. A nonlimiting example of an Fe(III) compound used in the iron oxide precursor solutions of the present invention is iron acetylacetonate. Nonlimiting examples of Fe(0) compounds used in the solutions include iron pentacarbonyl and triiron dodecacarbonyl. Nonlimiting examples of indium compounds used in the solutions include indium acetylacetonate.

The organic solvent of the iron oxide precursor solution (10) is typically an organic alcohol or ether. Nonlimiting examples of organic alcohols include ethanol (e.g., 200 proof ethanol) and t-butanol. A nonlimiting example of an organic ether is tetrahydrofuran.

Indium-doped iron oxide precursor solutions (10) of the present invention typically contain a concentration of an iron-based organometallic ranging from 0.001M to 0.02M and an indium compound ranging from 0.00004M to 0008M. Oftentimes the concentration for the iron compound ranges from 0.003M to 0.015M and the indium compound ranges from 0.00012M to 0.0006M, and in some cases the concentration of the iron compound ranges from 0.005M to 0.011M, and the concentration of the indium compound ranges from 0.0002M to 0.00044M. Common concentrations for the iron compound and indium compound are 0.01M and 0.0004M respectively.

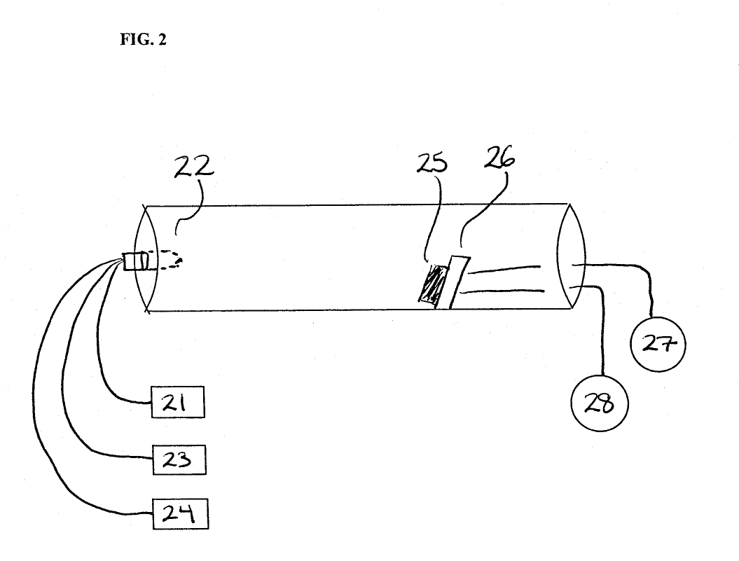

An ultrasonic spray pyrolysis apparatus is generally described in reference to FIG. 2. An indium-doped iron oxide precursor solution is pumped by a liquid feed (23) through an ultrasonic generator, (21) which is connected to a USP nozzle (22). Carrier gas (24) is fed into the generator (21), combining with the indium-doped iron oxide precursor solution, which emerges from the nozzle (22) as a micron-sized aerosol. The micron-sized aerosol hits a heated substrate (25) that is in contact with a platform (26), and the indium-doped iron precursor is pyrolyzed. Heat is provided to the substrate (25) through the platform (26), which is heated by a power source (28). The temperature of the platform (26) is controlled, and accordingly the temperature of the substrate (25), by a thermocouple (27).

Liquid feed (23) is typically a syringe pump, but may be any suitable apparatus providing a constant, controllable flow of iron precursor solution, and limiting the evaporation of the solvent. Liquid feed (23) usually pumps the solution at a rate ranging from 1.0 to 2.2 mL/min. Oftentimes, the solution is pumped at a rate of 1.3 to 1.9 mL/min, with 1.6 mL/min being common.

Carrier gas (24) typically flows at a rate ranging from 5.0 to 7.0 L/min. Oftentimes, the gas flows at a rate ranging from 5.5 to 6.5 L/min, with 6 L/min being common. Oxygen is usually used as the carrier gas.

Nozzle (22) contains an opening through which the ultrasonically generated aerosol emerges (e.g., Lechler Model US-1 ultrasonic nozzle with a working frequency of 100 kHz). Typically, the size of the orifice is 1 mm. Oftentimes, the median droplet size ranges from 16 to 24 μm, and in certain cases the median size ranges from 18 to 22 μm. A median size of 20 μm is common.

Substrate (25) is typically a spectrally transparent cyclic-olefin copolymer. In certain cases, however, it may be pure poly(norbornene) or a conducting glass plate having an F-doped SnO₂ overlayer.

The temperature of substrate (25) in the apparatus is typically below 400° C. Oftentimes, the temperature is below 350° C. or 325° C. In certain cases, the temperature is below 300° C., 275° C., or even 250° C.

The combination of nanostructured indium-doped iron oxide and a conductive substrate may be used as a photo-anode in a photocatalytic cell. Such anodes typically exhibit a maximum incident photon to current conversion efficiency (“IPCE”) of at least 10%, when spectral photoresponses of the anodes are recorded in 0.1 M NaOH_{(aq)}. Oftentimes a maximum IPCE of at least 15% or 20% is exhibited. In certain cases, a maximum IPCE of at least 25%, 30% or 35% is exhibited.

The following are nonlimiting examples of various nanostructured indium-doped iron oxides of the present invention:

1. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

2. Indium-doped iron oxide film ranging in thickness from 20 nm to 200 nm; indium amount ranging from 2% to 10% by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

3. Indium-doped iron oxide film ranging in thickness from 20 nm to 200 nm; indium amount ranging from 3% to 7% by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

4. Indium-doped iron oxide film ranging in thickness from 20 nm to 200 nm; less than 10% indium by weight; less than 10% Fe₂O₃ and/or In₂O₃; less than 10% indium ferrate; at least 25 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

5. Indium-doped iron oxide film ranging in thickness from 20 nm to 200 nm; less than 10% indium by weight; less than 10% Fe₂O₃ and/or In₂O₃; less than 10% indium ferrate; at least 50 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

6. Indium-doped iron oxide film ranging in thickness from 20 nm to 200 nm; less than 10% indium by weight; less than 10% Fe₂O₃ and/or In₂O₃; less than 10% indium ferrate; at least 75 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

7. Indium-doped iron oxide film ranging in thickness from 20 nm to 200 nm; less than 10% indium by weight; less than 10% Fe₂O₃ and/or In₂O₃; less than 10% indium ferrate; at least 100 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

8. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 20° and 160° relative to the film surface plane.

9. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 4:1; radius of disc-like structures ranging from 0.25 nm to 6 nm; disc-like structures oriented at an angle between 20° and 160° relative to the film surface plane.

10. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 5:1; radius of disc-like structures ranging from 0.25 nm to 6 nm; disc-like structures oriented at an angle between 20° and 160° relative to the film surface plane.

11. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 6:1; radius of disc-like structures ranging from 0.25 nm to 6 nm; disc-like structures oriented at an angle between 20° and 160° relative to the film surface plane.

12. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.38 nm to 5.5 nm; disc-like structures oriented at an angle between 20° and 160° relative to the film surface plane.

13. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.5 nm to 5.1 nm; disc-like structures oriented at an angle between 20° and 160° relative to the film surface plane.

14. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 40° and 140° relative to the film surface plane.

15. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 60° and 120° relative to the film surface plane.

16. Indium-doped iron oxide film ranging in thickness from 20 nm to 200 nm; less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle of approximately 90° relative to the film surface plane.

17. Indium-doped iron oxide film ranging in thickness from 20 nm to 200 nm; indium amount ranging from 3% to 7% by weight; less than 5% Fe₂O₃ and/or In₂O₃; less than 5% indium ferrate; at least 25 disc-like structures on the film surface within a 0.25 μm² area; disc-like structures roughly spherical with a ratio of long dimension to short being at least 3:1; radius of disc-like structures ranging from 0.38nm to 5.5 nm; disc-like structures oriented at an angle between 40° and 140° relative to the film surface plane.

18. Indium-doped iron oxide film ranging in thickness from 20 nm to 200 nm; indium amount ranging from 3% to 7% by weight; less than 5% Fe₂O₃ and/or In₂O₃; less than 5% indium ferrate; at least 50 disc-like structures on the film surface within a 0.25 μm² area; disc-like structures roughly spherical with a ratio of long dimension to short being at least 4:1; radius of disc-like structures ranging from 0.38 nm to 5.5 nm; disc-like structures oriented at an angle between 60° and 120° relative to the film surface plane.

19. Indium-doped iron oxide film ranging in thickness from 20 nm to 200 nm; indium amount ranging from 3% to 7% by weight; less than 5% Fe₂O₃ and/or In₂O₃; less than 5% indium ferrate; at least 75 disc-like structures on the film surface within a 0.25 μm² area; disc-like structures roughly spherical with a ratio of long dimension to short being at least 4:1; radius of disc-like structures ranging from 0.38 nm to 5.5 nm; disc-like structures oriented at an angle between 60° and 120° relative to the film surface plane.

20. Indium-doped iron oxide film ranging in thickness from 20 nm to 200 nm; indium amount ranging from 3% to 7% by weight; less than 10% Fe₂O₃ and/or In₂O₃; less than 10% indium ferrate; at least 100 disc-like structures on the film surface within a 0.25 μm² area; disc-like structures roughly spherical with a ratio of long dimension to short being at least 4:1; radius of disc-like structures ranging from 0.38 nm to 5.5 nm; disc-like structures oriented at an angle between 60° and 120° relative to the film surface plane.

The following are nonlimiting examples of various method steps one can use to produce nanostructured indium-doped iron oxides of the present invention:

1. Generation of a micron-sized aerosol of an indium-doped iron oxide precursor solution; the precursor solution includes an iron-based organometallic at a concentration ranging from 0.001M to 0.02M and an indium-based organmetallic compound at a concentration ranging from 0.00004M to 0.0008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium doped iron oxide; the nanostructured indium-doped iron oxide is less than 10% indium by weight, less than 10% Fe₂O₃ and/or In₂O₃, and less than 10% indium ferrate.

2. Generation of a micron-sized aerosol of an indium-doped iron oxide precursor solution; the precursor solution includes iron acetylacetonate, iron pentacarbonyl, or iron dodecacarbonyl at a concentration ranging from 0.001M to 0.02M and indium acetylacetonate at a concentration ranging from 0.00004M to 0.008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

3. Generation of a micron-sized aerosol of an iron oxide precursor solution; the precursor solution includes an iron-based organometallic at a concentration ranging from 0.003M to 0.015M and an indium compound at a concentration ranging from 0.00012M to 0.0006M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured iron oxide; the nanostructured indium-doped iron oxide is less than 10% indium by weight, less than 10% Fe₂O₃ and/or In₂O₃, and less than 10% indium ferrate.

4. Generation of a micron-sized aerosol of an indium-doped iron oxide precursor solution; the precursor solution includes an iron-based organometallic at a concentration ranging from 0.005M to 0.011M and an indium compound at a concentration ranging from 0.0002M to 0.00044M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

5. Generation of a micron-sized aerosol of an indium-doped iron oxide precursor solution; the precursor solution includes an iron-based organometallic at a concentration ranging from 0.001M to 0.02M and an indium compound at a concentration ranging from 0.0004M to 0.0008M in 200 proof ethanol; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

6. Generation of a micron-sized aerosol of an indium-doped iron oxide precursor solution; the precursor solution includes an iron-based organometallic at a concentration ranging from 0.001M to 0.02M and an indium compound at a concentration ranging from 0.00004M to 0.0008M in t-butanol; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

7. Generation of a micron-sized aerosol of an indium-doped iron oxide precursor solution; the precursor solution includes an iron-based organometallic at a concentration ranging from 0.001M to 0.02M and an indium compound at a concentration ranging from 0.0004M to 0.0008M in tetrahydrofuran; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

8. Generation of a micron-sized aerosol of an indium-doped iron oxide precursor solution; the precursor solution includes an iron-based organometallic at a concentration ranging from 0.001M to 0.02M and an indium compound at a concentration ranging from 0.00004M to 0.0008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 350° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

9. Generation of a micron-sized aerosol of an indium-doped iron oxide precursor solution; the precursor solution includes an iron-based organometallic at a concentration ranging from 0.001M to 0.02M and an indium compound at a concentration ranging from 0.0004M to 0.0008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 325° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

10. Generation of a micron-sized aerosol of an indium-doped iron oxide precursor solution; the precursor solution includes an iron-based organometallic at a concentration ranging from 0.001M to 0.02M and an indium compound at a concentration ranging from 0.0004M to 0.0008M in either an organic alcohol or ether; directing the aerosol to a heated substrate; the substrate is either a spectrally transparent cyclic-olefin copolymer or a pure poly(norbornene); the substrate temperature is below 300° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

11. Generation of a micron-sized aerosol of an indium-doped iron oxide precursor solution; the precursor solution includes an iron-based organometallic at a concentration ranging from 0.001M to 0.02M and an indium compound at a concentration ranging from 0.00004M to 0.0008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 275° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

12. Generation of a micron-sized aerosol of an indium-doped iron oxide precursor solution; the precursor solution includes an iron-based organometallic at a concentration ranging from 0.001M to 0.02M and an indium compound at a concentration ranging from 0.00004M to 0.0008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 250° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

13. Generation of a micron-sized aerosol of an indium-doped iron oxide precursor solution; the precursor solution includes an iron-based organometallic at a concentration ranging from 0.001M to 0.02M and an indium compound at a concentration ranging from 0.00004M to 0.0008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 5% Fe₂O₃ and/or In₂O₃, and less than 10% indium ferrate.

14. Generation of a micron-sized aerosol of an iron-doped iron oxide precursor solution; the precursor solution includes an iron-based organometallic at a concentration ranging from 0.001M to 0.02M and an indium compound at a concentration ranging from 0.00004M to 0.0008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 5% Fe₂O₃ and/or In₂O₃, and less than 5% indium ferrate.

15. Generation of a micron-sized aerosol of an indium-doped iron oxide precursor solution; the precursor solution includes iron acetylacetonate at a concentration ranging from 0.001M to 0.02M and indium acetylacetonate at a concentration ranging from 0.00004M to 0.0008M in either an organic alcohol or ether; directing the aerosol to a heated substrate; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

16. Generation of a micron-sized aerosol of an indium-doped iron oxide precursor solution; the precursor solution includes iron acetylacetonate at a concentration ranging from 0.001M to 0.02M and indium acetylacetonate at a concentration ranging from 0.00004M to 0.0008M in either an organic alcohol or ether; directing the aerosol to a heated substrate using oxygen as a carrier gas; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

17. Generation of a micron-sized aerosol of an indium-doped iron oxide precursor solution; the precursor solution includes iron acetylacetonate at a concentration ranging from 0.003M to 0.015M and indium acetylacetonate at a concentration ranging from 0.00012M to 0.0006M in 200 proof ethanol; directing the aerosol to a heated substrate using oxygen as a carrier gas; the substrate is either a: a) spectrally transparent glass with a conductive overlayer, or, b) spectrally transparent cyclic-olefin copolymer or a pure poly(norbornene); the substrate temperature is below 400° C.; allowing the indium-doped iron oxide precursor to pyrolyze on the substrate surface to produce the indium-doped nanostructured iron oxide; the nanostructured indium-doped iron oxide is less than 10% indium by weight, less than 10% Fe₂O₃ and/or In₂O₃, and less than 10% indium ferrate.

18. Generation of a micron-sized aerosol of an indium-doped iron oxide precursor solution; the precursor solution includes iron acetylacetonate at a concentration ranging from 0.005M to 0.011M and indium acetylacetonate at a concentration ranging from 0.0002M to 0.00044M in 200 proof ethanol; directing the aerosol to a heated substrate using oxygen as a carrier gas; the substrate is either a: a) spectrally transparent glass with a conductive overlayer, or, b) spectrally transparent cyclic-olefin copolymer; the substrate temperature is below 400° C.; allowing the indium-doped iron oxide precursor to pyrolyze on the substrate surface to produce the nanostructured indium-doped iron oxide; the nanostructured indium-doped iron oxide is less than 10% indium by weight, less than 10% Fe₂O₃ and/or In₂O₃, and less than 10% indium ferrate.

19. Generation of a micron-sized aerosol of an indium-doped iron oxide precursor solution; the precursor solution includes iron acetylacetonate at a concentration ranging from 0.005M to 0.011M and indium acetylacetonate at a concentration ranging from 0.0002M to 0.00044M in 200 proof ethanol; directing the aerosol to a heated substrate using oxygen as a carrier gas; the substrate is either a: a) spectrally transparent glass with a conductive overlayer, or, b) spectrally transparent cyclic-olefin copolymer; the substrate temperature is below 350° C.; allowing the indium-doped iron oxide precursor to pyrolyze on the substrate surface to produce the nanostructured indium-doped iron oxide; the nanostructured indium-doped iron oxide is less than 10% indium by weight, less than 5% Fe₂O₃ and/or In₂O₃, and less than 10% indium ferrate.

20. Generation of a micron-sized aerosol of an indium-doped iron oxide precursor solution; the precursor solution includes iron acetylacetonate at a concentration ranging from 0.005M to 0.011M and indium acetylacetonate at a concentration ranging from 0.0002M to 0.00044M in 200 proof ethanol; directing the aerosol to a heated substrate using oxygen as a carrier gas; the substrate is either a: a) spectrally transparent glass with a conductive overlayer, or, b) a spectrally transparent cyclic-olefin copolymer; the substrate temperature is below 300° C.; allowing the indium-doped iron oxide precursor to pyrolyze on the substrate surface to produce the nanostructured indium-doped iron oxide; the nanostructured indium-doped iron oxide is less than 10% indium by weight, less than 5% Fe₂O₃ and/or In₂O₃, and less than 5% indium ferrate.

The following are nonlimiting examples of photo-anodes constructed from nanostructured indium-doped iron oxide of the present invention:

1. Combination of substrate and indium-doped iron oxide film; substrate is either a: a) spectrally transparent glass with a conductive overlayer, or, b) spectrally transparent cyclic-olefin copolymer or pure poly(norbornene); indium-doped iron oxide film ranging in thickness from 20 nm to 200 nm; film less than 10% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

2. Combination of substrate and indium-doped iron oxide film; substrate is either a: a) spectrally transparent glass with a conductive overlayer, or, b) spectrally transparent cyclic-olefin copolymer or pure poly(norbornene); indium-doped iron oxide film ranging in thickness from 20 nm to 200 nm; film less than 5% indium by weight; less than 10% Fe₂O₃ and/or In₂O₃; less than 10% indium ferrate; at least 10 disc-like structures on the film surface within a 0.25 μm² area; disc-like structures roughly spherical with a ratio of long dimension to short being at least 2:1; radius of disc-like structures ranging from 0.25 nm to 6 nm; disc-like structures oriented at an angle between 20° and 160° relative to the film surface plane.

3. Combination of substrate and indium-doped iron oxide film; substrate is either a: a) spectrally transparent glass with a conductive overlayer, or, b) spectrally transparent cyclic-olefin copolymer or pure poly(norbornene); indium-doped iron oxide film ranging in thickness from 20 nm to 200 nm; film less than 10% indium by weight; less than 5% Fe₂O₃ and/or In₂O₃; less than 5% indium ferrate; at least 25 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 40° and 140° relative to the film surface plane.

4. Combination of substrate and indium-doped iron oxide film; substrate is either a: a) spectrally transparent glass with a conductive overlayer, or, b) spectrally transparent cyclic-olefin copolymer; indium-doped iron oxide film ranging in thickness from 20 nm to 200 nm; film ranging from 2% to 10% indium by weight; less than 5% Fe₂O₃ and/or In₂O₃; less than 5% indium ferrate; at least 25 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 40° and 140° relative to the film surface plane.

5. Combination of substrate and indium-doped iron oxide film; substrate is either a: a) spectrally transparent glass with a conductive overlayer, or, b) spectrally transparent cyclic-olefin copolymer; indium-doped iron oxide film ranging in thickness from 20 nm to 200 nm; film ranging from 3% to 7% indium by weight; less than 5% Fe₂O₃ and/or In₂O₃; less than 5% indium ferrate; at least 25 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 60° and 120° relative to the film surface plane.

6. Combination of substrate and indium-doped iron oxide film; substrate is either a: a) spectrally transparent glass with a conductive overlayer, or, b) spectrally transparent cyclic-olefin copolymer; indium-doped iron oxide film ranging in thickness from 20 nm to 200 nm; film ranging from 3% to 7% indium by weight; less than 5% Fe₂O₃ and/or In₂O₃; less than 5% indium ferrate; at least 50 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 60° and 120° relative to the film surface plane.

7. Combination of substrate and indium-doped iron oxide film; substrate is either a: a) spectrally transparent glass with a conductive overlayer, or, b) spectrally transparent cyclic-olefin copolymer; indium-doped iron oxide film ranging in thickness from 20 nm to 200 nm; film ranging from 3% to 7% indium by weight; less than 5% Fe₂O₃ and/or In₂O₃; less than 5% indium ferrate; at least 50 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 60° and 120° relative to the film surface plane; IPCE of at least 15%.

8. Combination of substrate and indium-doped iron oxide film; substrate is either a: a) spectrally transparent glass with a conductive overlayer, or, b) spectrally transparent cyclic-olefin copolymer; indium-doped iron oxide film ranging in thickness from 20 nm to 200 nm; film ranging from 3% to 7% indium by weight; less than 5% Fe₂O₃ and/or In₂O₃; less than 5% indium ferrate; at least 50 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 60° and 120° relative to the film surface plane; IPCE of at least 20%.

9. Combination of substrate and indium-doped iron oxide film; substrate is either a: a) spectrally transparent glass with a conductive overlayer, or, b) spectrally transparent cyclic-olefin copolymer; indium-doped iron oxide film ranging in thickness from 20 nm to 200 nm; film ranging from 3% to 7% indium by weight; less than 5% Fe₂O₃ and/or In₂O₃; less than 5% indium ferrate; at least 50 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 60° and 120° relative to the film surface plane; IPCE of at least 25%.

10. Combination of substrate and indium-doped iron oxide film; substrate is either a: a) spectrally transparent glass with a conductive overlayer, or, b) spectrally transparent cyclic-olefin copolymer; indium-doped iron oxide film ranging in thickness from 20 nm to 200 nm; at least 95% of the material in the a-hematite form; at least 50 disc-like structures on the film surface within a 0.25 μm² area; disc-like structures roughly spherical with a ratio of long dimension to short being at least 3:1; radius of disc-like structures ranging from 0.25 nm to 6 nm; disc-like structures oriented at an angle between 60° and 120° relative to the film surface plane; IPCE of at least 30%.

1. An indium-doped iron oxide film, wherein the film ranges in thickness from 20 nm to 200 nm, and wherein the film is less than 10% indium by weight and less than 10% Fe₂O₃ and In₂O₃ by weight and less than 10% indium ferrate by weight, and wherein there are at least 10 disc-like structures on the film surface within a 0.25 μm² area, and wherein the disc-like structures are roughly spherical in shape with a ratio of long dimension to short being at least 2:1, and wherein the radius of the disc-like structures ranges from 0.25 nm to 6 nm, and wherein the disc-like structures are oriented at an angle between 20° and 160° relative to the film surface plane.

2. The indium-doped iron oxide film according to claim 1, wherein the film is less than 5% Fe₂O₃ and/or In₂O₃by weight.

3. The indium-doped iron oxide film according to claim 1, wherein there are at least 25 disc-like structures on the film surface within a 0.25 μm² area.

4. The indium-doped iron oxide film according to claim 1, wherein the disc-like structures are oriented at an angle between 40° and 140° relative to the film surface plane.

5. The indium-doped iron oxide film according to claim 2, wherein the film is less than 5% indium ferrate by weight.

6. The indium-doped iron oxide film according to claim 5, wherein there are at least 25 disc-like structures on the film surface within a 0.25 μm² area.

7. The indium-doped iron oxide film according to claim 6, wherein the disc-like structures are oriented at an angle between 40° and 140° relative to the film surface plane.

8. A method of producing an indium-doped iron oxide film, wherein the method comprises the steps of:
a) generating a micron-sized aerosol of an indium-doped iron oxide precursor solution, wherein the precursor solution comprises an iron-based organometallic at a concentration ranging from 0.001M to 0.02 M and an indium-based organometallic compound at a concentration ranging from 0.00004M to 0.0008M in either an organic alcohol or ether;
b) directing the aerosol to a heated substrate, wherein the substrate is either a: a) spectrally transparent glass with a conductive overlayer, or, b) spectrally transparent cyclic-olefin copolymer or poly(norbornene), and wherein the substrate temperature is less than 400° C.; and,
c) allowing the indium-doped iron oxide precursor to pyrolyze on the substrate surface
thereby forming the indium-doped iron oxide film, wherein the indium-doped iron oxide is less than 10% indium by weight, and less than 10% Fe₂O₃ and In₂O₃by weight, and less than 10% indium ferrate by weight.

9. The method according to claim 8, wherein the precursor solution comprises iron acetylacetonate and indium acetylacetonate.

10. The method according to claim 8, wherein the precursor solution comprises 200 proof ethanol.

11. The method according to claim 8, wherein the substrate temperature is less than 350° C.

12. The method according to claim 8, wherein the indium-doped iron oxide film is less than 5% Fe₂O₃ and In₂O₃ by weight.

13. The method according to claim 12, wherein the precursor solution comprises iron acetylacetonate and indium acetylacetonate.

14. The method according to claim 13, wherein the substrate temperature is less than 300° C.

15. A photo-anode, wherein the photo-anode comprises:
a) a substrate, wherein the substrate is either a: a) spectrally transparent glass with a conductive overlayer, or, b) spectrally transparent cyclic-olefin copolymer or poly(norbornene); and,
b) an indium-doped iron oxide film, wherein the film ranges in thickness from 20 nm to 200 nm, and wherein the film is less than 10% indium by weight and less than 10% Fe₂O₃ and In₂O₃ by weight and less than 10% indium ferrate by weight, and wherein there are at least 10 disc-like structures on the film surface within a 0.25 μm² area, and wherein the disc-like structures are roughly spherical in shape with a ratio of long dimension to short being at least 2:1, and wherein the radius of the disc-like structures ranges from 0.25 nm to 6 nm, and wherein the disc-like structures are oriented at an angle between 20° and 160° relative to the film surface plane.

16. The photo-anode according to claim 15, wherein the indium-doped iron oxide film is less than 5% Fe₂O₃ and In₂O₃ by weight.

17. The photo-anode according to claim 15, wherein the substrate is either a: a) spectrally transparent glass with a conductive overlayer, or, b) spectrally transparent cyclic-olefin copolymer.
